(19) United States
(12) Patent Application Publication
(10) Pub. No.: US 2002/0117537 A1
(43) Pub. Date: Aug. 29, 2002

(54) Manufacturing method and apparatus of piston used in compressor

(76) Inventors: Takayuki Kato, Kariya-shi (JP); Fuminobu Enokijima, Kariya-shi (JP); Masaki Inoue, Kariya-shi (JP)

Correspondence Address: MORGAN & FINNEGAN, L.L.P., 345 Park Avenue, New York, NY, 10154, US

(21) Appl. No.: 10/081,272

(22) Filed: Feb. 21, 2002

(30) Foreign Application Priority Data
Feb. 23, 2001 (JP) 2001-047617

(51) Int. Cl. B23K 20/12; B23K 31/02

(52) U.S. Cl. 228/114.5; 228/112.1; 228/2.1; 228/160

(57) ABSTRACT

A hollow piston for use in a compressor includes a first piece and a second piece. The first piece has a skirt, which is to be engaged with a swash plate, and a cylindrical portion. The second piece is coupled to the first piece to cover an opening formed in one end of the cylindrical portion. A work includes a pair of the symmetrically arranged first pieces, which are coupled to each other at the skirts. The work is held against rotation about its axis and against axial movement. In this state, the second pieces are friction welded to the ends of the work. During friction welding, the second pieces are rotated in the opposite directions while being simultaneously pressed against the opened ends of the hollow cylindrical portions. As a result, deformation of the produced pistons is prevented.

### BACKGROUND OF THE INVENTION

The present invention relates to a method and an apparatus for manufacturing hollow pistons reciprocated by rotation of drive member, which rotates integrally with a rotary shaft of a compressor.

Japanese Laid-Open Patent Publication No. 11-107912 discloses a piston that is formed hollow for reducing weight. Such hollow pistons are advantageous for improving displacement control in a variable displacement compressor, which adjusts the pressure in a crank chamber for controlling the inclination angle of a swash plate accommodated in the crank chamber.

Japanese Laid-Open Patent Publication No. 2000-38987 discloses a method for manufacturing hollow pistons. A piston produced by the method includes a head. The head has a hollow cylindrical portion and a lid. One end of the cylindrical portion is open. The lid covers the opening of the cylindrical portion. The publication discloses friction welding as a method for coupling the lid to the cylindrical portion.

When friction welding a lid to a cylindrical portion, the cylindrical portion and the lid are pressed against each other and rotated with respect to each other. At this time, a support member holds the cylindrical portion. The support member must be locked against rotation relative to the cylindrical portion. Also, the support member must bear the thrusting force pressing the cylindrical portion and the lid against each other. It is therefore necessary to reliably hold the circumference of the cylindrical portion by the support member. However, if excessive, the force for holding the cylindrical portion will deform the cylindrical portion, which degrades the roundness of the cylindrical portion. The deformation of the cylindrical portion may be adjusted by machining. However, when calcinating a coating onto the cylindrical portion in the subsequent processes, the internal stress is released and deforms the completed piston. The deformation hinders the smooth reciprocation of the piston in a cylinder bore.

### SUMMARY OF THE INVENTION

Accordingly, it is an objective of the present invention to prevent deformation of hollow pistons that are produced by friction welding.

To achieve the foregoing and other objectives and in accordance with the purpose of the present invention, a method for manufacturing a hollow piston used in a compressor is provided. The compressor reciprocates the piston by a drive member when a rotary shaft rotates. The piston includes a first piece and a second piece. The second piece is coupled to the first piece. The method includes preparing a symmetrical work, wherein the work includes a pair of the symmetrically arranged first pieces, wherein the first pieces are coupled to or contact each other, and friction welding a pair of the second pieces to the work while simultaneously pressing the second pieces against the ends of the work.

The present invention may also be applied to an apparatus for manufacturing a hollow piston used in a compressor. The compressor reciprocates the piston by a drive member when a rotary shaft rotates. The piston includes a first piece and a second piece. The second piece is coupled to the first piece. The apparatus includes a holding mechanism for holding a symmetrical work and a pair of support mechanisms. The symmetrical work includes a pair of the symmetrically arranged first pieces. The first pieces are coupled to each other. The holding mechanism limits rotation of the work about the axis and axial movement of the work. The support mechanisms support the second pieces at the axial sides of the work. The support mechanisms rotate the second pieces while simultaneously pressing the second pieces against the work, thereby friction welding the second pieces to the work.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view illustrating a compressor according to a first embodiment of the present invention;

FIG. 2 is a cross-sectional view illustrating one of the pistons used in the compressor of FIG. 1;

FIG. 3 is an exploded perspective view illustrating a work and a pair of second pieces of the piston of FIG. 2;

FIG. 4 is a cross-sectional view illustrating a piston manufacturing apparatus;

FIG. 5 is a perspective view illustrating the piston manufacturing apparatus shown in FIG. 4;

FIG. 6 is a cross-sectional view taken along line 6-6 of FIG. 4;

FIG. 7 is a cross-sectional view taken along line 7-7 of FIG. 4;

FIG. 8 is a cross-sectional view taken along line 8-8 of FIG. 4;

FIG. 9 is a timing chart showing a friction welding process;

FIG. 10 is a cross-sectional view illustrating a piston manufacturing apparatus according to a second embodiment of the present invention;

FIG. 11(a) is an exploded perspective view illustrating a piston according to a third embodiment;

FIG. 11(b) is a perspective view illustrating the piston shown in FIG. 11(a); and

FIG. 11(c) is a cross-sectional view illustrating the piston shown in FIG. 11(b).

### DETAILED DESCRIPTION OF THE PREFERRED EMBODIMENTS

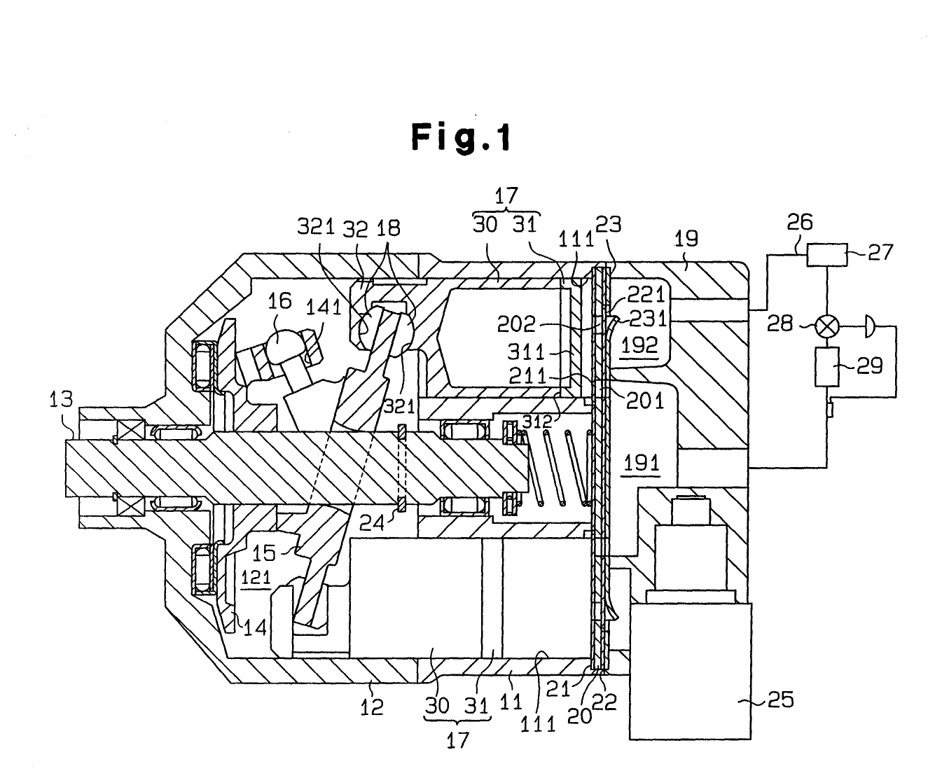

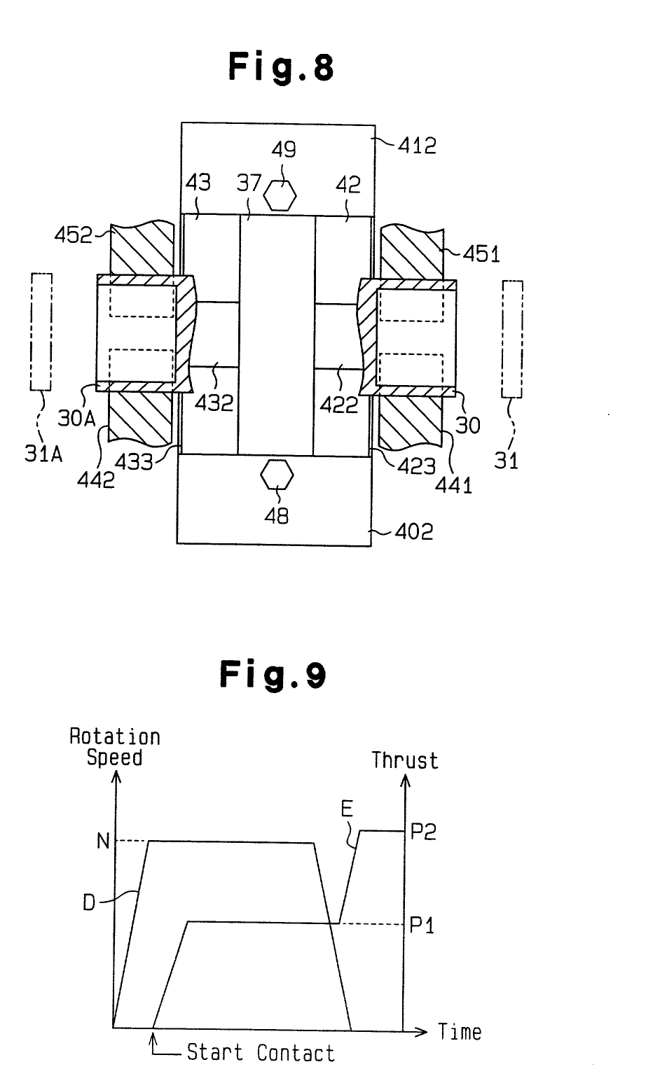

A first embodiment of the present invention will now be described with reference to FIGS. 1 to 9.

FIG. 1 illustrates the interior of a variable displacement compressor. The housing of the compressor includes a front housing member 12, a cylinder block 11 and a rear housing member 19. A valve plate assembly is held between the cylinder block 11 and the rear housing member 19. A control pressure chamber 121 is defined by the front housing member 12 and the cylinder block 11.

A rotary shaft 13 is supported by the front housing member 12 and the cylinder block 11 and extends through the control pressure chamber 121. The rotary shaft 13 is driven by an external drive source, for example, a vehicle engine. A rotor 14 is attached to the rotary shaft 13. Also, a drive member, which is a swash plate 15 in this embodiment, is supported by the rotary shaft 13. The swash plate 15 slides along and tilts with respect to the axis of the rotary shaft 13. A pair of guide pins 16 extend from the swash plate 15, and a pair of guide holes 141 are formed in the rotor 14. Each guide pin 16 is slidably engaged with the corresponding guide hole 141. The cooperation of the guide holes 141 and the guide pins 16 permits the swash plate 15 to tilt along the axis of the rotary shaft 13 and to rotate integrally with the rotary shaft 13. The tilting motion of the swash plate 15 is guided by the sliding motion between the guide holes 141 and the guide pins 16, and by the sliding motion of the swash plate 15 on the rotary shaft 13.

The inclination angle of the swash plate 15 is changed by controlling the pressure in the control pressure chamber 121. When the pressure in the control pressure chamber 121 is increased, the inclination angle of the swash plate 15 is decreased. When the pressure in the control pressure chamber 121 is lowered, the inclination angle of the swash plate 15 is increased. A suction chamber 191 and a discharge chamber 192 are defined in a rear housing member 19. Refrigerant in the control pressure chamber 121 flows out to the suction chamber 191 through a bleed passage (not shown). Refrigerant in the discharge chamber 192 is supplied to the control pressure chamber 121 through a supply passage (not shown). The supply passage is regulated by a displacement control valve 25. That is, the control valve 25 controls the flow rate of refrigerant supplied from the discharge chamber 192 to the control pressure chamber 121. When the flow rate of refrigerant supplied from the discharge chamber 192 to the control pressure chamber 121 is increased, the pressure in the control pressure chamber 121 is increased. When the flow rate of refrigerant supplied from the discharge chamber 192 to the control pressure chamber 121 is decreased, the pressure in the control pressure chamber 121 is lowered. Therefore, the inclination angle of the swash plate 15 is controlled by the control valve 25.

The abutment of the swash plate 15 against the rotor 14 determines the maximum inclination angle of the swash plate 15. The abutment of the swash plate 15 against a snap ring 24, which is attached to the rotary shaft 13, determines the minimum inclination angle of the swash plate 15.

Cylinder bores 111, only two of which are shown in the drawing, are defined in the cylinder block 11 about the rotary shaft 13. Each cylinder bore 111 accommodates a piston 17, which is made of aluminum or aluminum alloy. Rotation of the swash plate 15, which rotates integrally with the rotary shaft 13, is converted into reciprocation of each piston 17 in the corresponding cylinder bore 111 by shoes 18. The shoes 18 slidably contact the swash plate 15.

The valve plate assembly includes a valve plate 20, a suction valve flap plate 21, a discharge valve flap plate 22, and a retainer plate 23. Suction ports 201 and discharge ports 202 are formed in the valve plate 20. Each suction port 201 and each discharge port 202 correspond to one of the cylinder bores 111. Suction valve flaps 211 are formed in the suction valve flap plate 21. Each suction valve flap 211 corresponds to one of the suction ports 201. Discharge valve flaps 221 are formed in the discharge valve flap plate 22. Each discharge valve flap 221 corresponds to one of the discharge ports 202. Retainers 231 are formed in the retainer plate 23. Each retainer 231 corresponds to one of the discharge valve flaps 221.

As each piston 17 is moved from the top dead center to the bottom dead center, refrigerant in the suction chamber 191 is drawn into the cylinder bore 111 through the associated suction port 201 while causing the associated suction valve flap 211 to flex to an open position. As the piston 17 is moved from the bottom dead center to the top dead center, refrigerant gas is discharged to the discharge chamber 192 through the associated discharge port 202 while causing the associated discharge valve flap 221 to flex to an open position. The opening amount of each discharge valve flap 221 is defined by contact between the valve flap 221 and the associated retainer 231.

The discharge chamber 192 is connected to the suction chamber 191 through an external refrigerant circuit 26. The external refrigerant circuit 26 includes a condenser 27, an expansion valve 28, and an evaporator 29. Refrigerant that flows out of the discharge chamber 192 to the external refrigerant circuit 26 returns to the suction chamber 191 through the condenser 27, the expansion valve 28, and the evaporator 29.

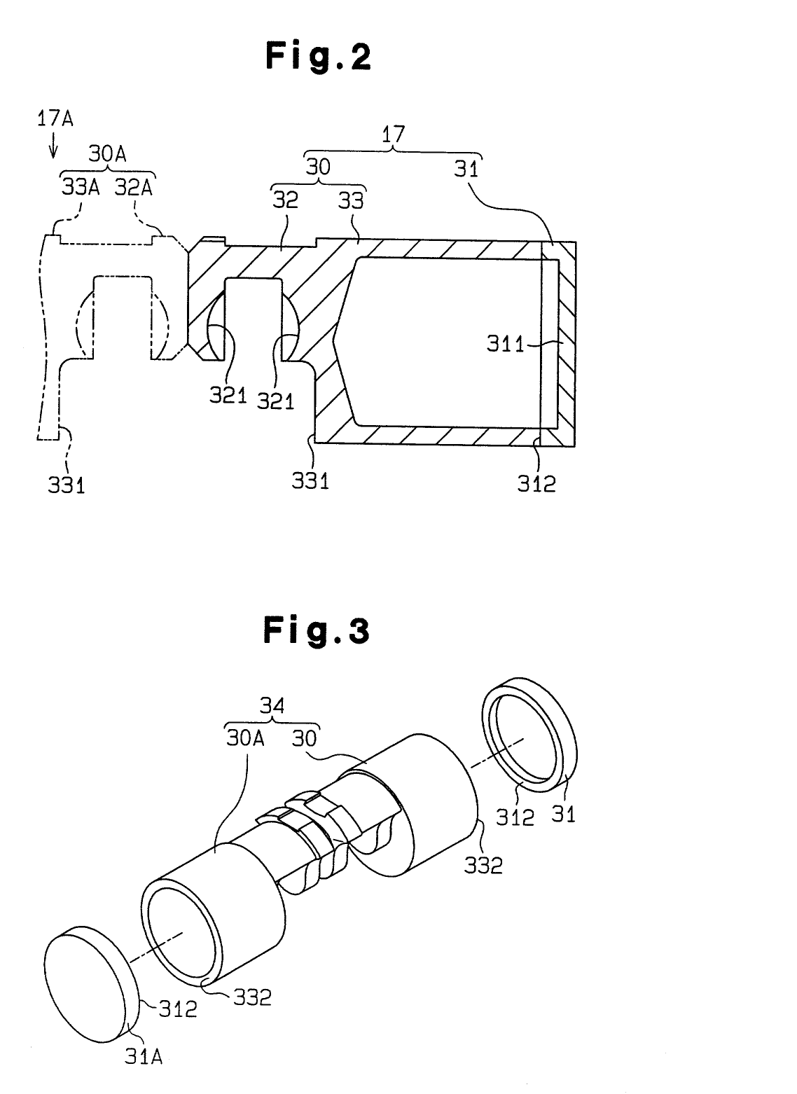

As shown in FIG. 2, each piston 17 has a hollow. Since all the pistons 17 are identical, the structure of one of the pistons 17 will be discussed below. The piston 17 is formed by coupling a first piece 30, which contacts the corresponding shoes 18, with a second piece 31, which includes an end wall 311. The end wall 311 is reciprocated in the associated cylinder bore 111. The first piece 30 includes a skirt 32 and a hollow cylindrical portion 33. The skirt 32 has a pair of facing recesses 321 to hold the corresponding shoes 18. A piston 17A, which is shown by broken lines in the drawings, is simultaneously manufactured with the piston 17.

FIG. 3 illustrates a work, which is a piston block 34 in this embodiment, the second piece 31 and another second piece 31A. The block 34 is previously manufactured to include the first pieces 30 and 30A facing and coupled to each other. That is, the piston block 34 includes the pieces 30, 30A, which are coupled to each other and symmetrical.

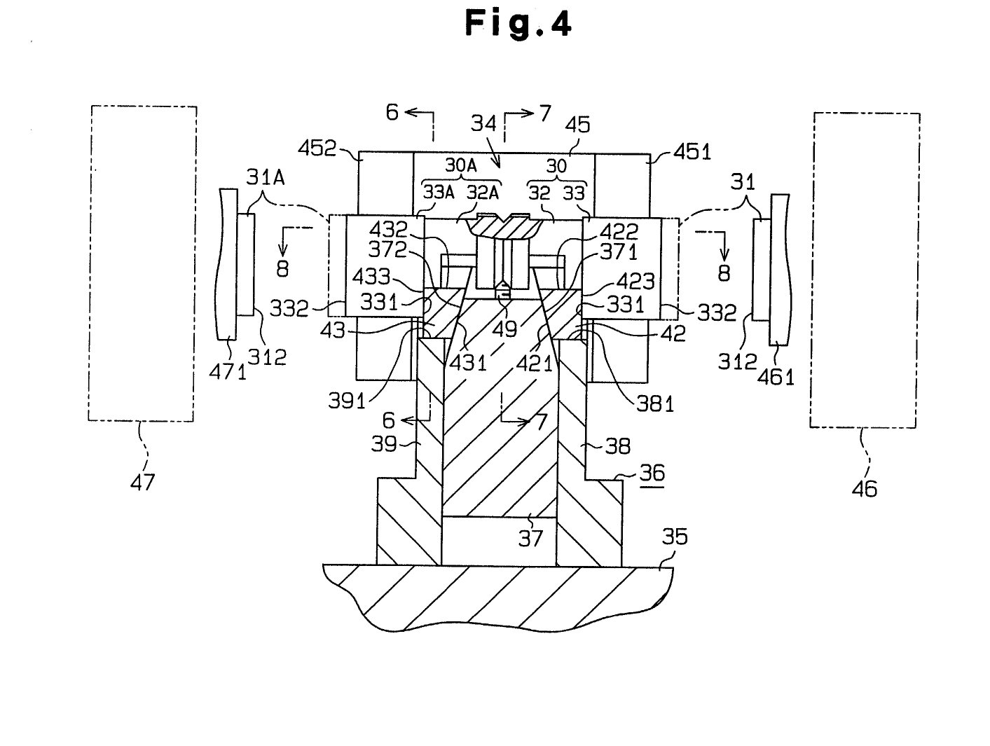

FIGS. 4 to 8 illustrate an apparatus for manufacturing the hollow pistons 17 and 17A from the a piston work shown in FIG. 3. As shown in FIG. 4, a guide block 36 is secured to a base 35. The guide block 36 is formed like a square frame. The guide block 36 includes facing long walls 38, 39 and facing short walls 40, 41 (see FIGS. 4 to 7). A wedge 37 is located in the guide block 36. The wedge 37 slides vertically and is locked against movement in the thickness direction of the long walls 38, 39 (to left and right as viewed in FIG. 4). Inclined surfaces 371, 372 are formed on upper sides of the wedge 37 that face the long walls 38, 39 such that the wedge 37 tapers towards the upper end.

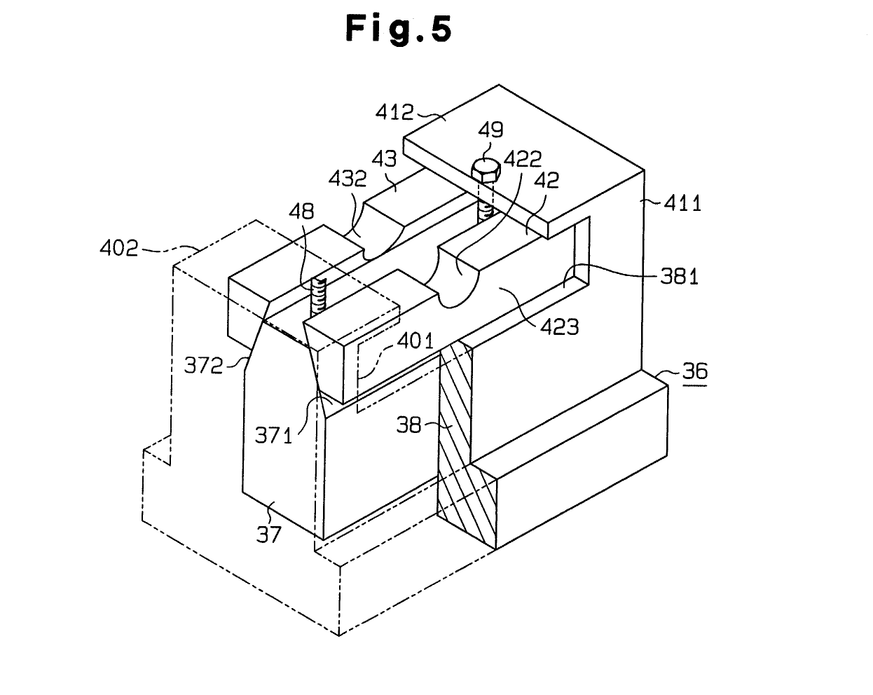

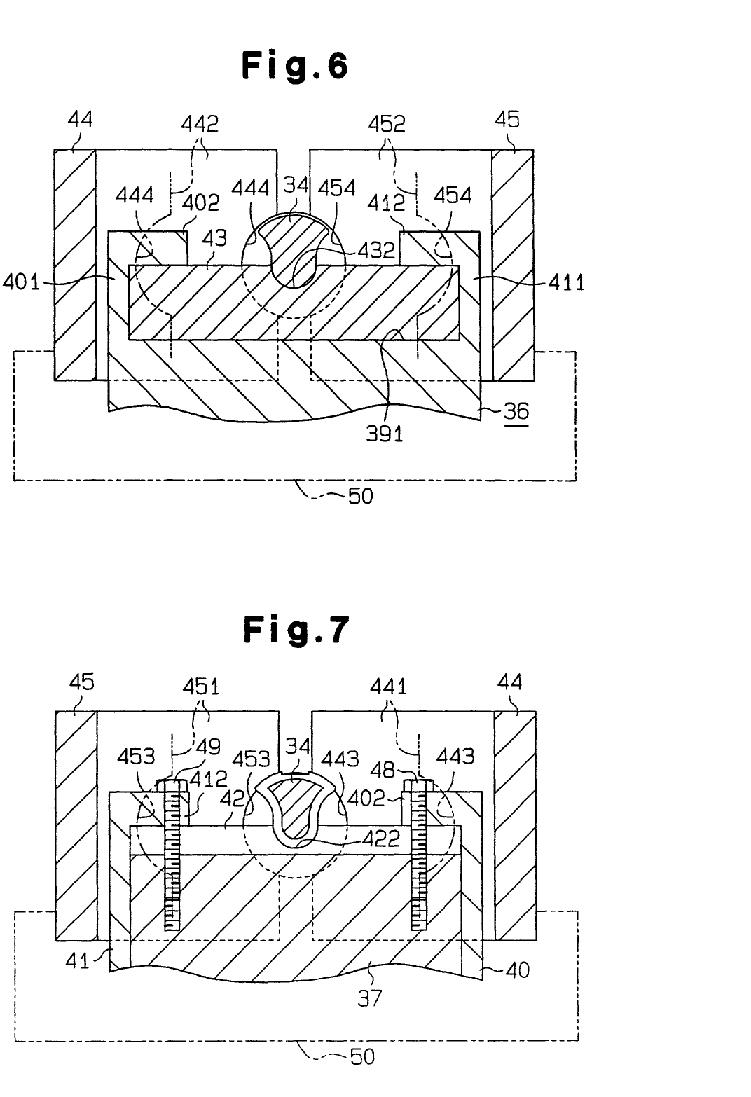

As shown in FIGS. 5 and 6, guide walls 401, 411 are formed integrally with the short walls 40, 41, respectively, and extend upward. Holding walls 402, 412 are integrally formed with the guide walls 401, 411, respectively, and extend toward each other. As shown in FIGS. 5 and 7, bolts 48, 49 extend through the holding walls 402, 412, respectively. The heads of the bolts 48, 49 engage with the holding walls 402, 412, respectively. The bolts 48, 49 are threaded to the wedge 37. The wedge 37 is suspended by the bolts 48, 49. The vertical position of the wedge 37 is changed by rotating the bolts 48, 49.

As shown in FIG. 4, a first stopper 42 is located on the upper surface 381 of the long wall 38. The first stopper 42 slides in the thickness direction of the long wall 38 (to left and right as viewed in FIG. 4). A second stopper 43 is located on the upper surface 391 of the long wall 39. The second stopper 43 slides in the thickness direction of the long wall 39 (to left and right as viewed in FIG. 4). The first and second stoppers 42, 43 are urged toward each other by urging means (not shown). Inclined surfaces 421 and 431 are formed on the first and second stoppers 42, 43, respectively, to face each other. The urging means causes the inclined surface 371 and the inclined surface 372 of the wedge 37 to contact the inclined surface 421 of the first stopper 42 and the inclined surface 431 of the second stopper 43, respectively.

As shown in FIGS. 5, 6 and 7, arcuate recesses 422 and 432 are formed in the upper sides of the first and second stoppers 42, 43, respectively. The skirts 32 of the pistons 17, 17A are fitted in the arcuate recesses 422, 432, respectively.

A holder 44 is located adjacent to the guide block 36 to surround the short wall 40. A holder 45 is located adjacent to the guide block 36 to surround the short wall 41. The holder 44 includes a pair of holding projections 441, 442. The holder 45 includes a pair of holding projections 451 452. The holding projections 441, 451 face each other and extend to be parallel to the long wall 38. The holding projections 442, 452 face each other and extend to be parallel to the long wall 39. The holders 44, 45 are supported by a force applying mechanism 50 such that the holders 44, 45 are moved toward and away from each other (to left and right as viewed in FIGS. 6 and 7). Holding recesses 443, 444, 453, 454 are formed in the distal ends of the holding projections 441, 442, 451, 452, respectively. The cylindrical portions 33 of the pistons 17, 17A are fitted in the holding recesses 443, 444, 453, 454.

As shown in FIG. 4, a first rotation support mechanism 46 is located to the right of the guide block 36, and a second rotation support mechanism 47 is located to the left of the guide block 36. The first and second rotation support mechanisms 46, 47 have rotatable chucks 461, 471, respectively. The chucks 461, 471 hold the second pieces 31, 31A, respectively, and are moved in the axial direction.

The second pieces 31, 31A are coupled to the block 34 in the following manner.

As shown in FIG. 4, the piston block 34 is placed on the recesses 422, 432 of the first and second stoppers 42, 43. The first and second stoppers 42, 43 are placed such that the distance between the stopper surfaces 423, 433 of the stoppers 42, 43 is shorter than the distance between the jaws 331 of the cylindrical portions 33, 33A. After the block 34 is placed on the first and second stoppers 42, 43, the wedge 37 is lifted by fastening the bolts 48, 49. At this time, contact between the inclined surfaces 371 and 372 of the wedge 37 and the inclined surface 421 of the first stopper 42 and the inclined surface 431 of the stopper 43 causes the first and second stoppers 42, 43 to move away from each other. Accordingly, the stopper surface 423 of the first stopper 42 contacts the jaw 331 of the cylindrical portion 33, and the stopper surface 433 of the second stopper 43 contacts the jaw 331 of the cylindrical portion 33A. Since the wedge 37 cannot be moved to left and right as viewed in FIG. 4, or in thrust direction, the block 34 cannot be moved in the thrust direction when the stopper surfaces 423, 433 of the stoppers 42, 43 contact the jaws 331. In other words, the axial position of the block 34 is determined.

After the position of the block 34 is determined, the force applying mechanism 50 is activated. Accordingly, the cylindrical portion 33 is held between the recesses 443, 453, and the cylindrical portion 33A is held between the recesses 444, 454. The holding projections 441, 442, 451 and 452 are pressed against the block 34 by a predetermined thrust, which locks the block 34 against rotation.

Line D in FIG. 9 represents rotation speed of the second pieces 31, 31A based on the operation of the first and second rotation supporting mechanism 46, 47. Line E represents thrust, or force pressing the second pieces 31, 31A against the block 34. The chuck 461 holding the second piece 31 approaches the block 34 while being rotated at rotation speed N by the first rotation supporting mechanism 46. The chuck 471 holding the second piece 31A approaches the block 34 while being rotated at rotation speed N by the second rotation supporting mechanism 47. The chucks 461, 471 are rotated in the opposite directions at the same speed N. The chucks 461, 471 approach the block 34 until an annular contact surface 312 of each second piece 31, 31A contacts a contact surface 332 of the corresponding cylindrical portion 33, 33A. The second pieces 31, 31A are pressed against the block 34 by a first thrust P1 for a predetermined period. Then, the rotation speed of the chucks 461, 471 is decelerated to zero while the thrust applied to the second pieces 31, 31A is increased from P1 to P2 (P2>P1). The increase of the thrust is started after the deceleration of the rotation speed of the chucks 461, 471 is started and before the rotation speed is zero. Friction welding is performed in this manner. Accordingly, the second pieces 31, 31A are integrated with the block 34 at the contact surfaces 312, 332. Thereafter, the bolts 48, 49 are loosened to lower the wedge 37, which causes the stoppers 42, 43 to be separated from the jaws 331 of the cylindrical portions 33 by the urging means. In other words, the block 34 is released from the stoppers 42, 43. Then, the block 34 is cut such that the skirts 32, 32A are separated to produce the pistons 17, 17A at the same time.

The first embodiment has the following advantages.

(1) The thrusts P1 (P2) are applied to the second pieces 31, 31A, which are held by the chucks 461, 471, from the opposite directions. The thrusts P1 (P2) therefore cancel each other through the block 34, which has a symmetrical shape. Therefore, the thrust applied from the holding projections 441, 442, 451, 452 to the block 34 for preventing the block 34 from rotating need not act against the thrust acting on the second pieces 31, 31A. That is, the force for locking the block 34 against rotation need not be greater than the level that is sufficient for preventing the rotation. As a result, the cylindrical portions 33, 33A, which are held by the holding projections 441, 442, 451, 452, are prevented from being deformed. Accordingly, the pistons 17, 17A are prevented from being deformed.

(2) When the second pieces 31, 31A are being friction welded to the block 34, the block 34 is locked against rotation. The block 34 is formed integral and corresponds to the first pieces 30, 30A coupled at the opposite ends. Locking the block 34, which is formed integral, against rotation is easier than locking two or more members against rotation. That is, adoption of the block 34, the form of which corresponds to the first pieces 30, 30A coupled at the opposite ends, is advantageous for producing the two pistons 17, 17A simultaneously.

(3) The block 34, which is cut in half, includes the skirts 32, 32A, which are coupled at the opposite ends. After the second pieces 31, 31A are friction welded to the block 34, the block 34 is cut such that the skirts 32, 32A are separated. When cutting the block 34, the skirts 32, 32A may be unevenly separated. That is, the distances from the jaws 331 to the cut surface of the skirts 32, 32A may be uneven. However, even if the distances are uneven, the top dead center, at which the end wall 311 of the second pieces 31, 31A is closest to the suction valve flap plate 21, is not changed. In other words, even if the skirts 32, 32A are unevenly separated, the pistons 17, 17A, which are produced simultaneously, can be used without problems.

(4) When being friction welded to the block 34, the second pieces 31, 31A are rotated in the opposite directions. The force rotating the second piece 31 and the force rotating the second piece 31A act against each other while the second pieces 31, 31A contact the block 34. That is, the second pieces 31, 31A are rotated in the opposite directions while being pressed against the block 34. This method permits the force for locking the block 34 against rotation to be further reduced. Particularly, since the second pieces 31, 31A are rotated at the same speed in the opposite directions, the force rotating the second piece 31 and the force rotating the second piece 31A cancel each other through the block 34. Therefore, the force for locking the block 34 against rotation is minimized.

(5) Metal material that consists predominantly of aluminum is light and is therefore advantageous in reducing weight in parts. Also, the metal material melts at a lower temperature than iron and is favorable in friction welding. Thus, friction welding is favorable for manufacturing hollow pistons 17, 17A, which are made of the material, which consists predominantly of aluminum.

(6) The holders 44, 45 and the force applying mechanism 50 lock the piston block 34 against rotation. The stoppers 42, 43 and the wedge 37 determine the position of the block 34 in the thrust direction, or the axial direction. The holders 44, 45, the force applying mechanism 50, the stoppers 42, 43, and the wedge 37 function as a block holding mechanism for locking the block 34 against rotation and for limiting the movement of the block 34 in the thrust direction. The first rotation support mechanism 46, which includes the chuck 461, presses the second piece 31 against the block 34 and rotatably supports the second piece 31. The second rotation support mechanism 47, which includes the chuck 471, presses the second piece 31A against the block 34 and rotatably supports the second piece 31A. The piston manufacturing apparatus, which includes the block holding mechanism, the first rotation support mechanism 46, and the second rotation support mechanism 47, simultaneously friction welds the second pieces 31, 31A to the block 34. That is, the piston manufacturing apparatus according to the present invention produces a pair of pistons simultaneously while preventing the pistons from being deformed.

(7) If the block 34 is displaced in the thrust direction during friction welding, the second pieces 31, 31A are not reliably coupled to the block 34. If the second pistons 31, 31A start being friction welded to the block 34 at different times, the second piece (31 or 31A) that contacts the block 34 first starts receiving thrust earlier. This thrust is received by the wedge 37. Therefore, the block 34 is not displaced in the thrust direction.

(8) The wedge 37 is urged in a direction that is perpendicular to the thrust direction and urges the stoppers 42, 43 in the opposite directions. The wedge 37 functions as a limiting member, which prevents the block 34 from moving in the thrust direction. The structure of the above embodiment, in which the wedge 37 and the stoppers 42, 43 cooperate to limit the position of the block 34, readily limits the position of the block 34.

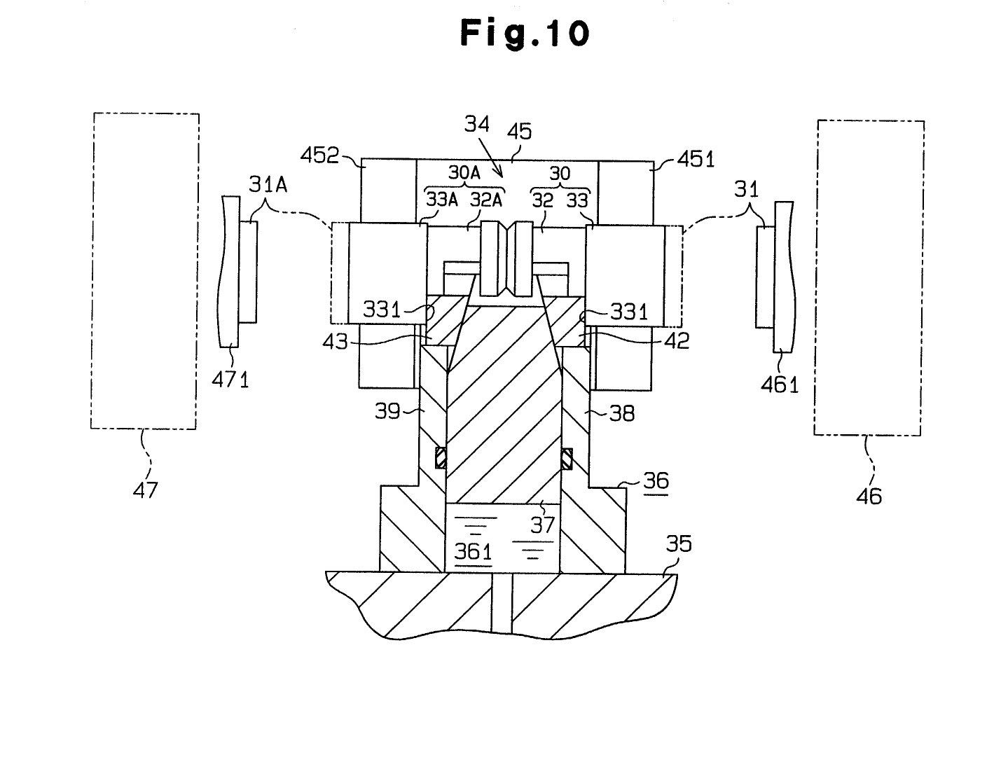

A second embodiment will now be described with reference to FIG. 10. Like or the same reference numerals are given to those components that are like or the same as the corresponding components of the first embodiment.

An oil pressure chamber 361 is defined in the guide block 36. Oil of a predetermined pressure is supplied to the oil pressure chamber 361. The wedge 37 is raised by the pressure of the oil supplied to the oil pressure chamber 361. Accordingly, the stoppers 42, 43 engage with the jaws 331 of the cylindrical portions 33 of the block 34. When the supply of oil to the oil pressure chamber 361 is stopped, the wedge 37 is lowered, and the stoppers 42, 43 are separated from the jaws 331 by the urging means. Using oil pressure to press the stoppers 42, 43 against the block 34 is advantages in an automated process for manufacturing the pistons 17, 17A through friction welding.

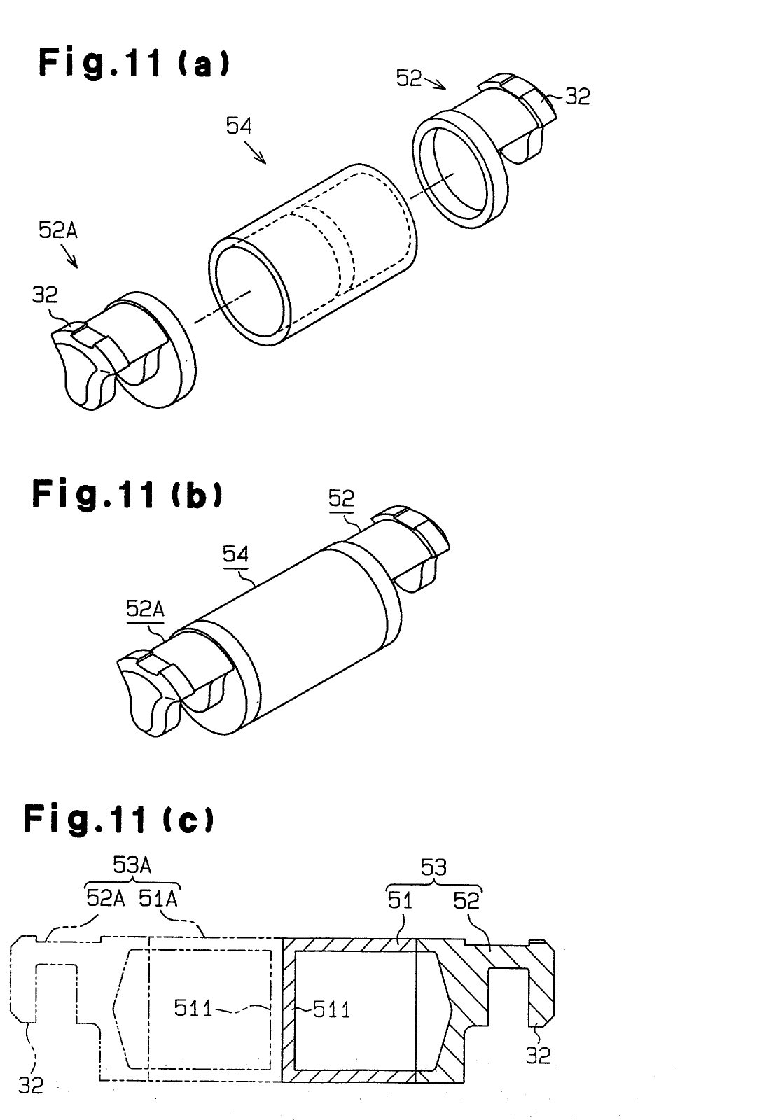

A third embodiment will now be described with reference to FIGS. 11(a), 11(b) and 11(c). Like or the same reference numerals are given to those components that are like or the same as the corresponding components of the first embodiment.

As shown in FIG. 11(c), pistons 53, 53A each have a hollow. Each piston 53, 53A has a first piece 51, 51A and a second piece 52, 52A. Each first piece 51, 51A has a hollow cylindrical portion and an end wall 511. Each second piece 52, 52A includes a skirt 32. Each second piece 52, 52A is friction welded to the corresponding first piece 51, 51A.

As shown in FIG. 11(a), a piston block 54 includes the first pieces 51, 51A, which are coupled at the opposite ends. The second pieces 52, 52A are simultaneously friction welded to the piston block 54. FIG. 11(b) illustrates a state in which the second pieces 52, 52A are coupled to the piston block 54. After the friction welding, the piston block 54 is cut such that the first pieces 51, 51A are separated.

It should be apparent to those skilled in the art that the present invention may be embodied in many other specific forms without departing from the spirit or scope of the invention. Particularly, it should be understood that the invention may be embodied in the following forms.

(1) In the first embodiment, the first pieces 30, 30A may be separated prior to the friction welding of the second pieces 31, 31A. When the second pieces 31, 31A are being friction welded, the first pieces 30, 30A are held contacting each other and are locked against rotation.

(2) In the third embodiment, the first pieces 51, 51A may be separated prior to the friction welding of the second pieces 52, 52A. When the second pieces 52, 52A are being friction welded, the first pieces 51, 51A are held contacting each other and are locked against rotation.

(3) The present invention may be applied to the manufacture of double-headed pistons.

Therefore, the present examples and embodiments are to be considered as illustrative and not restrictive and the invention is not to be limited to the details given herein, but may be modified within the scope and equivalence of the appended claims.

What is claimed is:

1. A method for manufacturing a hollow piston used in a compressor, wherein the compressor reciprocates the piston by a drive member when a rotary shaft rotates, wherein the piston includes a first piece and a second piece, the second piece being coupled to the first piece, the method comprising:
preparing a symmetrical work, wherein the work includes a pair of the symmetrically arranged first pieces, wherein the first pieces are coupled to or contact each other; and
friction welding a pair of the second pieces to the work while simultaneously pressing the second pieces against the ends of the work.

2. The method according to claim 1, wherein the work is an integral object that is formed by coupling the first pieces to each other, the method further including cutting the work for obtaining two pistons after the second pieces are friction welded to the work.

3. The method according to claim 1, wherein the second pieces are rotated in the opposite directions when being friction welded to the work.

4. The method according to claim 3, wherein the second pieces are rotated at the same speed.

5. The method according to claim 1, wherein each first piece includes a part of the corresponding piston that is to be engaged with the drive member.

6. The method according to claim 1, wherein the work and the second pieces are made of metal material that consists predominantly of aluminum.

7. A method for manufacturing a hollow piston used in a compressor, wherein the compressor reciprocates the piston by a drive member, which rotates integrally with a rotary shaft, wherein the piston includes a first piece and a second piece, wherein the first piece includes a skirt, which is engaged with the drive member, and a hollow cylindrical portion, and wherein the second piece is coupled to the first piece to cover an opening formed at one end of the cylindrical portion, the method comprising:
preparing a symmetrical work, wherein the work includes a pair of the symmetrically arranged first pieces, wherein the first pieces are coupled to each other at the skirts; and
friction welding a pair of the second pieces to the ends of the work, wherein, during the friction welding, the second pieces are simultaneously pressed against the opened ends of the cylindrical portions, respectively, and are rotated in the opposite directions.

8. The method according to claim 7, further comprising cutting the work at the axial center for obtaining two pistons after the second pieces are friction welded to the work.

9. The method according to claim 7, wherein, when the second pieces are being friction welded to the symmetrical work, the second pieces are rotated at the same speed.

10. An apparatus for manufacturing a hollow piston used in a compressor, wherein the compressor reciprocates the piston by a drive member when a rotary shaft rotates, wherein the piston includes a first piece and a second piece, the second piece being coupled to the first piece, the apparatus comprising:
a holding mechanism for holding a symmetrical work, which includes a pair of the symmetrically arranged first pieces, the first pieces being coupled to each other, wherein the holding mechanism limits rotation of the work about its axis and axial movement of the work; and
a pair of support mechanisms for supporting the second pieces at the axial sides of the work, wherein the support mechanisms rotate the second pieces while simultaneously pressing the second pieces against the work, thereby friction welding the second pieces to the work.

11. The manufacturing apparatus according to claim 10, wherein the holding means includes:
first and second stoppers, which are movable in the axial direction of the work and are engageable with the work, wherein, when the first stopper is engaged with the work, the work is prevented from moving in one direction along its axis, and wherein, when the second stopper is engaged with the work, the work is prevented from moving in another direction along its axis; and
limiting member, wherein the limiting member urges the stoppers in the opposite directions to engage the stoppers with the work, thereby limiting axial movement of the work.

12. The manufacturing apparatus according to claim 11, wherein the limiting member is movable in a direction that is perpendicular to the moving direction of the stoppers, wherein the limiting member includes a pair of inclined surfaces, wherein each stopper includes an inclined surface, which contacts one of the inclined surfaces of the limiting member, and wherein, as the limiting member moves, the inclined surfaces cooperate to move the stoppers away from each other.

13. The manufacturing apparatus according to claim 10, wherein the support mechanisms rotate the second pieces in the opposite directions.

14. The manufacturing apparatus according to claim 13, wherein the support mechanisms rotate the second pieces at the same speed.
